(19) United States
(12) Patent Application Publication
(10) Pub. No.: US 2011/0083015 A1
(43) Pub. Date: Apr. 7, 2011

(54) SYSTEM AND METHOD FOR AN ELECTRONIC SIGNATURE FOR QUICK AND EFFICIENT DATA AUTHENTICATION

(75) Inventor: Remo Meier, Wurenlingen (CH)

(73) Assignee: Eidgenossiche Technische Hochschule Zurich, Zurich (CH)

(21) Appl. No.: 12/573,596

(22) Filed: Oct. 5, 2009

(51) Int. Cl. H04L 9/00

(52) U.S. Cl. 713/176

(57) ABSTRACT

System and method for generating an electronic signature to authenticate data includes generating a private and a public key using the last value in a hash chain formed from the private key as a starting point, signing a message m, using a distinct set of hash chains using a second secure hash value of the message m and a counter c, selecting a block offset using the hash value of the selected chains, the message m, and the counter c, generating the signature from the selected seals and the counter. The electronic signature validity is verified by synchronizing a verification unit with a source of a signed message, computing expected chains by hashing the signed message m and a counter c with a first hash function, computing a set of expected block offsets by hashing the signed message m, counter c, and computed chains with a second hash function.

### FIELD

The present invention relates to a system and method for the authentication of data in real-time transmissions, and in particular to a one-time signature scheme implemented within the propagation delay of a communication network.

### BACKGROUND

The peer-to-peer paradigm can be applied to more than just file sharing. Recently, there is a trend towards peer-to-peer applications that need to deliver data in real-time, examples of such applications include live streaming systems and massive multiplayer games. Due to the possible presence of malicious peers, it becomes vital to provide security to all participating peers. In particular, all data blocks of a peer-to-peer live stream need to be authenticated by each peer such that fraudulent blocks injected by intermediate peers can be detected.

In applications such as file-sharing where all data blocks to be distributed are available at the beginning authentication is pretty straight-forward; essentially a peer is able to authenticate the data by first retrieving a signature—normally a small list of hash values, one for each block of the data—from the source through a secure channel.

In contrast, real-time applications such as multiplayer games and live streaming face the challenge of authenticating data that is just being created. If the peer-to-peer paradigm is used to distribute the data, there is an additional catch: intermediate peers must authenticate data blocks before forwarding them to other peers, preventing a ruinous snowball effect of proliferating fraudulent packets, which could waste precious bandwidth.

Commonly used signatures schemes are based on mathematical problems such as the hardness of factoring integer numbers or the hardness of computing discrete logarithms, where the factorization or the discrete logarithm, respectively acts as a trapdoor to sign data blocks and is kept secret as private key. The disadvantages are a high computational complexity and large signatures to counter ever more sophisticated attacks. Clearly, such schemes do not allow to sign data blocks fitting into a network's maximum transfer unit of typically 1,500 bytes. But also amortizing the signature costs over multiple blocks is also not an option for peer-to-peer systems. For example, compiling and distributing signed hash lists more than doubles delays. Further, a larger block size imposes more delays with each hop taken in the network transmission.

What is missing from the art is a solutions applicable to massive multiplayer peer-to-peer games with even more stringent timing constraints. The present invention addresses this and other needs.

### SUMMARY

In one embodiment, the present invention provides a method for generating an electronic signature to authenticate data. The method includes the steps of generating, by a private key generation subunit, a private key comprised of uniformly random chosen values; creating, by a public key generation unit, a public key using a last value in a hash chain formed from using a first secure hash function H: {0,1}^{q}→{0,1 } with security parameter q and the private key values as starting points, wherein the hash chain has 1 blocks each of a size b, and the hash chain has a length of bl+1 blocks; encoding, by a signing unit, a message m, wherein the encoding includes the steps of: selecting, by a chain selection unit, a distinct set of hash chains using a second secure hash value of the message m and a counter c, wherein the second secure hash function is denoted by H_{{1, . . . , n}}^{λ,distinct}, wherein λ is the number of chains in the set; selecting, by an offset selection unit, a block offset for each selected hash chain by adding the selected chains, the message m, and the counter c in a third hash function denoted by H_{{1, . . . , b}}^{λ-1} (m, c, c₁, . . . , c_{λ}); creating the electronic signature s_{c1,uc1,p1}, . . . , s_{cλ,ucλ,pλ} of the message m, by a signature generator, wherein c₁, . . . , c_{λ}} represents the selected chains, {p₁, . . . , p₈₀ } represents the block offsets and {u_{c1}, . . . , u_{cλ}} represents indices of the blocks.

In another embodiment the present invention provides a method for verifying a validity of an electronic signature. The method includes the steps of: weakly synchronizing a verification unit with a source of a signed message by receiving a seal in the electronic signature from the source or a trusted third party; computing, by a verifying unit, a set of expected chains by hashing the signed message m and a counter c with a first hash function denoted H_{{1, . . . , n}}^{λdistinct} (m, c); computing, by a verifying unit, a set of expected block offsets by hashing the signed message m, the counter c, and the computed chains {c₁, . . . c_{λ}} with a second hash function denoted H_{{1, . . . , b}}^{λ-1} (m, c, c₁, . . . , c_{λ}); determining the validity of the electronic signature.

In another embodiment the present invention provides a system for generating an electronic signature to authenticate data. The system including a private key generation subunit configured to generate a private key comprised of uniformly random chosen values; a public key generation unit configured to generate a public key using a last value in a hash chain formed from using a first secure hash function H: {0,1}^{q}→0,1 with security parameter q and the private key value as starting points, wherein the hash chain has/blocks each of a size b, and the hash chain has a length of bl+1 blocks; a signing unit configured to encode a message m, wherein the signing unit includes: a chain selection unit configured to select a distinct set of hash chains using a second secure hash value of the message m and a counter c, wherein the second secure hash function is denoted by H_{{1, . . . , n}}^{λ,distinct}, wherein λ is the number of chains in the set; an offset selection unit configured to select a block offset for each selected hash chain by adding the selected chains, the message m, and the counter c in a third hash function denoted by H_{{1, . . . , b}}^{λ-1} (m, c, c₁, . . . , c_{λ}); and a signature generator configured to create an electronic signature s_{c1,uc1,p1}, . . . , s_{cλ,ucλ,pλ} of the message m, wherein {c₁, . . . , cλ} represents the selected chains, {p₁, . . . , p_{λ}} represents the block offsets and {u_{c1}, . . . , u_{cλ}} represents indices of the blocks.

The system further includes a verification unit configured to be a verification unit configured to be weakly synchronized with a source of a signed message, wherein the synchronization is done with a seal in an electronic signature received from the source or a trusted third party; a verifying unit configured to compute a set of expected chains by hashing the signed message m and a counter c with the second secure hash function; a verifying unit configured to compute a set of expected block offsets by hashing the signed message m, the counter c, and the computed chains {c₁, . . . c_{λ}} with the third hash function; and the verification unit further configured to determine the validity of the electronic signature.

### BRIEF DESCRIPTION OF THE DRAWING FIGURES

FIG. 1 depicts a conventional peer-to-peer network;

FIG. 2 is a block diagram in accordance with an embodiment of the present invention;

FIGS. 3A-3C illustrate a process in accordance with an embodiment of the present invention; and

FIG. 4 is depicts synchronization ratio curves among peers in accordance with an embodiment of the present invention.

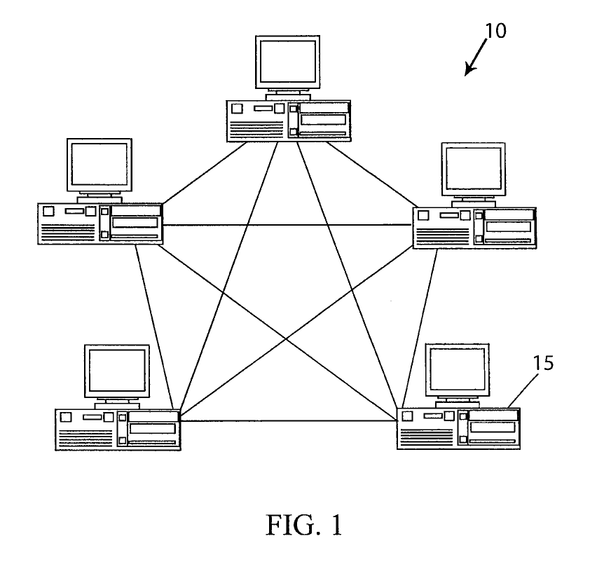

### DETAILED DESCRIPTION

By way of overview and introduction, provided is a signature scheme for broadcast authentication tailored towards peer-to-peer systems to overcome limitations of traditional approaches based on signature schemes like the RSA and DSA algorithms, most notably in terms of delays, signature size, and computational complexity. This signature scheme can have practical interest for other real-time applications such as massive multiplayer peer-to-peer gaming.

Live streaming is one of many applications where data is continuously created and has to be quickly distributed among a large number of users. The peer-to-peer paradigm overcomes the scalability issues associated with more centralized approaches of network communication schemes. Because data blocks travel along multiple (even possibly malicious) peers, authenticating the origin of blocks becomes of prime importance to guarantee safety and reliability. The asymmetry of a single source and an arbitrary number of untrusted receivers requires the use of digital signatures and public key cryptography in general.

Embodiments of the present invention extend existing one-way signature schemes such that they can be used for live peer-to-peer applications. Existing schemes either need a public key which is several hundred kilobytes long, or need all available processing power to manage authentication only, or waste a too large part of each packet for authentication. The present signature scheme, Authenticating Live Peer-to-Peer Streams (ALPS) trade-offs between the three main properties: public key size, signature size, and computational delay. For example, ALPS signatures can be between about 20 to 40 bytes in size; signing and verification typically takes between merely about 10 to 300 μs; and a public key of about a few kilobytes in size is sufficient to authenticate a live stream. Overall, ALPS is about two orders of magnitude more efficient than previous schemes. By yielding two orders of magnitudes in improved efficiency, implementation of APLS makes low-delay and authenticated live peer-to-peer streams practical.

In a peer-to-peer streaming platform, which supports live streaming, incorporating an embodiment of the present invention can reduce propagation delays compared to other peer-to-peer streaming systems. Implementation of ALPS in such a peer-to-peer platform reduces propagation delay because ALPS can work with small blocks of data that can be quickly authenticated and forwarded.

Digital signatures are used to verify the source of data (authentication) and are omnipresent in information technology. A data source receives a private and a public key. The private key is secret and enables signatures to be generated for data to be distributed. The public key is publicly known and allows a recipient to verify, by way of the signature, whether the data received originate from the correct transmitter and that they have not been modified during transmission. However, signatures cannot be generated using the public key. Fields of application of digital signatures range from real-time applications such as the live streaming of radio and television signals over the Internet and computer games to applications in wireless networks. A common feature of all these applications is that they generate and distribute new data continuously. Digital signatures should therefore always be used when untrusted persons, or computers, transmit data. In peer-to-peer-based systems, where users share data with one another, it is particularly important that data is always signed so as to minimize abuse.

The use of digital signatures also has drawbacks. The complex mathematical functions of the prior art are costly in terms of the time required to generate and verify a signature and the quantity thereof. Under the prior art functions, it is not possible to sign a large number of small data packets quickly.

For example, signing one hundred data packets of one thousand bytes per packet every second would exceed the processing power of many computers. Furthermore, the signatures, with a typical size of 50-256 bytes per packet, would represent a considerable portion of all transmitted data. For this reason, existing digital signature methods are only used for data packets of larger volume, thus reducing the percentage of total data traffic taken up by signatures. However, this conventional approach is problematic for real-time applications. New data is initially buffered by the generator, and only signed and transmitted when a predefined data volume has been reached. In the same way, incoming data has to be buffered by a verifier until all the data is available and the signature allows to authenticate the data, leading to more delays with each hop in a peer-to-peer network. This buffering time manifests itself as an undesirable increase in the delay in transmission to recipients.

Embodiments of the present invention provide a digital signature method for real-time applications. This inventive digital signature method is between about 10 and 100 times faster than conventional methods and, thus, generates and efficiently verifies signatures. At about 25-50 bytes, the generated signatures are smaller than those used in conventional signature methods. At a few thousand bytes, the private and public keys used are only marginally larger than existing ones, and are still easy to handle in practice.

The digital signature method embodying the present invention is based on generating a plurality of hash chains. A hash chain is generated by repeatedly applying a hash function to a randomly selected value. Known hash functions include the Message-Digest algorithm 5 (MD5), or the Secure Hash Algorithm (SHA-1) promulgated by the U.S. National Institute of Standards and Technology.

Embodiments of the present invention provide a process where the first value of each chain—i.e., the random value—becomes part of the private key. The final value of each chain becomes part of the public key. Since hash functions by definition are very difficult to invert, only the holder of the private key can recalculate all the values of the hash chain easily. The signature of a data packet consists of individual entries of different hash chains. When generating a new signature, only hash values not previously used before are selected.

All the hash chains are divided into a plurality of non-overlapping blocks, with each block therefore consisting of a fixed number of hash values. To generate a signature, a value is selected from the next, as yet unused, block from each hash chain used. Not all available hash chains will be used to generate a signature. A hash value such as MD5 or SHA-1 of the data to be signed is used to select the chain used. The same method is also used to select a block position within the next unused block of every selected chain. This method makes it very unlikely that two different data packets have the same signature. Furthermore, it is all but impossible to produce a data packet that matches a given signature. To increase security, it is also required that the sum of all block positions corresponds to a predetermined constant. This constant is defined by the number of the hash values in a signature and by the block size.

In order to increase security further, a fixed number of previous data packets are each hashed to a bit. The suffix of the signature of the next data packet must correspond to the concatenation of this bit. This means that not all signatures generated are valid. Since the process of calculating the signatures is, however, very fast for the holder of the private key, the only consequence of this is a justifiable additional overhead for the data generator. In return, the likelihood of an attacker generating a valid falsified signature is reduced.

In order to enable users joining an already-running data transfer for the first time to verify data packets, the signatures generated are supplemented by conventional hash lists. A list of hash values with a value for each data packet is generated and signed using a conventional signature method such as RSA or DSA. These lists are supplied to all users as soon as they are available. By downloading these hash lists as well as the current data packets and the signatures thereof, a new user can quickly determine the current blocks of all the hash chains and thus verify the source of future data packets.

The high performance of the signature method embodying the present invention is ensured by the fact that all the operations used, in particular the handling of hash chains, are extremely efficient. Costly operations such as performing RSA and DSA calculations are only used periodically. Furthermore, individual hash values are markedly smaller than values used in RSA and DSA signatures, thus resulting in signatures of a smaller size. Embodiments of the present invention make it possible and practical for the first time to sign many small data packets in a short amount of time. Thus, enabling achievement of secure peer-to-peer live streaming, live gaming or sensor network solutions.

Message Authentication Codes (MAC) allow efficient authentication of data with a secret key shared between sender and receiver. Unfortunately, shared secret keys allow receivers to sign packets as well, rendering MACs unsuitable for applications where receivers are not trustworthy. In contrast, signature schemes based on asymmetric cryptography distribute a public key among all receivers, but keep a private key secret at the source. The most prominent asymmetric schemes are RSA, DSA, and Elliptic Curve Digital Signature Algorithm (ECDSA), a variant of DSA. However, due to the computational complexity and signature size of these conventional schemes, they do not allow to sign a large number of small data blocks that can fit into a network packet, for example about 1,500 bytes in size.

In another signature scheme, known as McEliece, features signatures as small as eighty-seven bits. The computational costs of several seconds needed by McEliece to sign and verify data blocks prevent its use in the peer-to-peer context. Similarly, the Quartz signature scheme creates signatures of 128 bits in size and is simple to verify, but it also takes seconds to sign data blocks.

Other prior efforts have focused on amortizing signature costs over a number of network packets while maintaining, for example, security in case of packet loss. Such schemes have to either work with large blocks or assume an offline setting where all blocks are known from start to the source. But either situation is not an option for peer-to-peer live streaming since data is continuously created and has to be authenticated before forwarding. Further, authenticating a block also requires the complete download of the block, which in turn leads to more delays as the size of the block increases with each hop across the network.

A scheme based on multiple MACs that avoids complex signature schemes was proposed by Canetti et al., Multicast Security: A Taxonomy and Some Efficient Constructions, IEEE Infocom, LNCS, Vol. 1294, 1999. A block is signed with all MACs, but each receiver does not hold only a subset of the corresponding secret keys, not all. Under this scheme a receiver is no longer able to sign blocks for other receivers if subsets of secret keys are carefully assigned to receivers. Unfortunately, the approach becomes impractical for a large number of receivers and possible collusions among them. A solution known as Timed Efficient Stream Loss-tolerant Authentication (TESLA) operates in a similar fashion. Here, a MAC authenticates a data block, but its secret key is revealed only later after the packet has been distributed (based on commitments to secret keys and hash chains). Unfortunately, TESLA is incompatible with the peer-to-peer paradigm since peers could no longer authenticate blocks before forwarding them.

Signatures schemes like RSA, DSA, and ECDSA make use of complex mathematical assumptions to obtain a trapdoor as a private key. Signatures based on arbitrary one-way functions without the need for trapdoors entail less mathematical assumptions, which in turn allows the use of simple and efficient functions like MD5 and SHA-1. Drawbacks of these conventional schemes are large keys and the availability of a single signature that also limits signing to a single block. The concept of a hash tree allows the use of multiple constructions of digital signature instances to sign more than one block. However, interest has mostly been of theoretical nature as signature size and key size, as well as the limited number signatures generally prevented their use in practice.

A bins and balls (BiBa) signature scheme uses one-way functions without trapdoors, and features a low verification overhead and a relatively small signature size. BiBa is tailored towards broadcast authentication, i.e., verifying the origin of a sequence of packets. A signer thereby keeps a large number of hash chains secret, and includes in every new signature the next unused values of a few carefully selected chains. There are different flavors of the protocol. BiBa itself is based on the birthday paradox by finding k-way collisions to create signatures with k values. The Powerball signature scheme generalizes BiBa by working with more general patterns besides collisions. But the resulting faster verification comes with an increase in the time for signing messages and for key generation itself. The Hash to Obtain Random Subset (HORS) signature scheme selects chains directly using a secure hash function.

The problem of all three schemes, BiBa, HORS, and Powerball, is the number of chains. A large number of chains also yields a large public key. More importantly, verifiers have at all time to be aware of how many times each chain has been used so far. Otherwise, an attacker is able to forge signatures for new blocks by reusing parts of old signatures. In peer-to-peer systems, where peers are inherently unreliable, it can prove difficult to maintain this kind of synchronization for a large number of chains. For the same reasons, an instance can only be used a few times during the propagation delay of the overlay. Consequently, multiple instances might have to be used, further increasing the size of the public key. Moving forward in all chains when signing a signature avoids synchronization problems, but wastes most items in the chains and increases the computational complexity as verifiers also have to skip the unused items.

### ALPS Signature Scheme

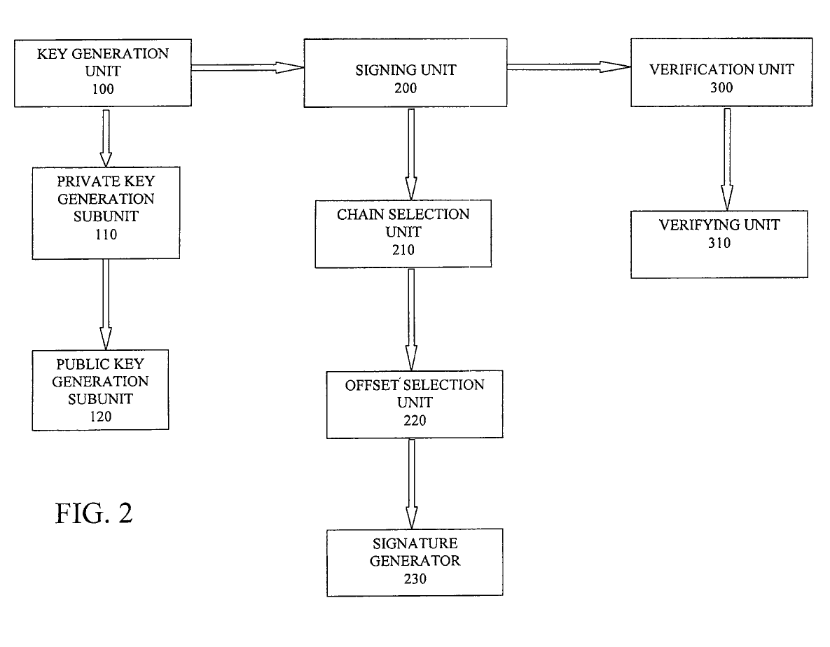

The ALPS signature scheme embodying the present invention authenticates sequences of data blocks, e.g., for a peer-to-peer live stream. ALPS signature scheme produces short signatures with low computational complexity; addresses the issues of large public keys and synchronization problems encountered in the known protocols discussed above, for example BiBa. As depicted in FIG. 2, the ALPS scheme is composed of three component units with associated algorithms: a key generation unit 100, a signing unit 200, and a verification unit 300. Each of these units can be implemented in hardware (for example, discrete components, a digital signal processor, a field programmable gate array, etc.) or in software operable to control a computer 15 connected in a peer-to-peer network 10.

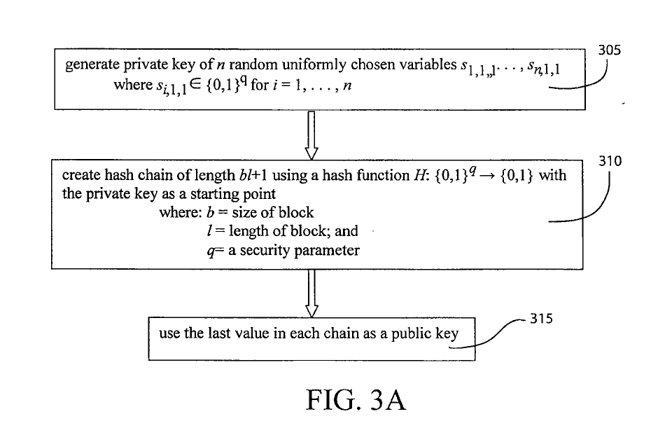

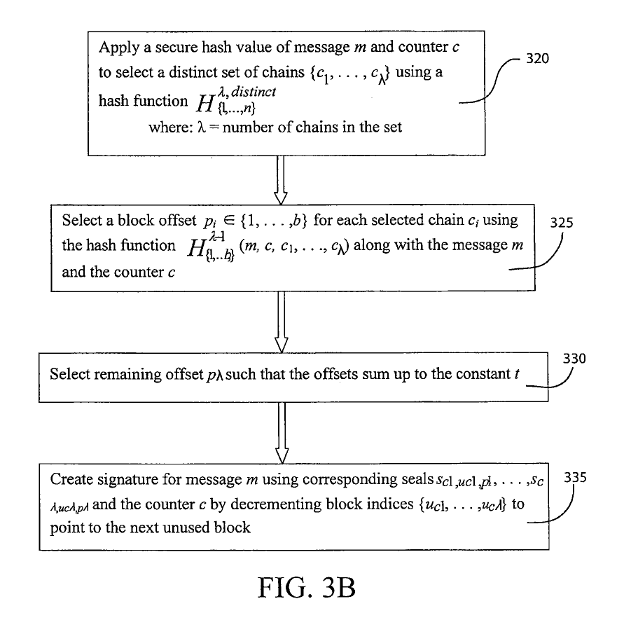

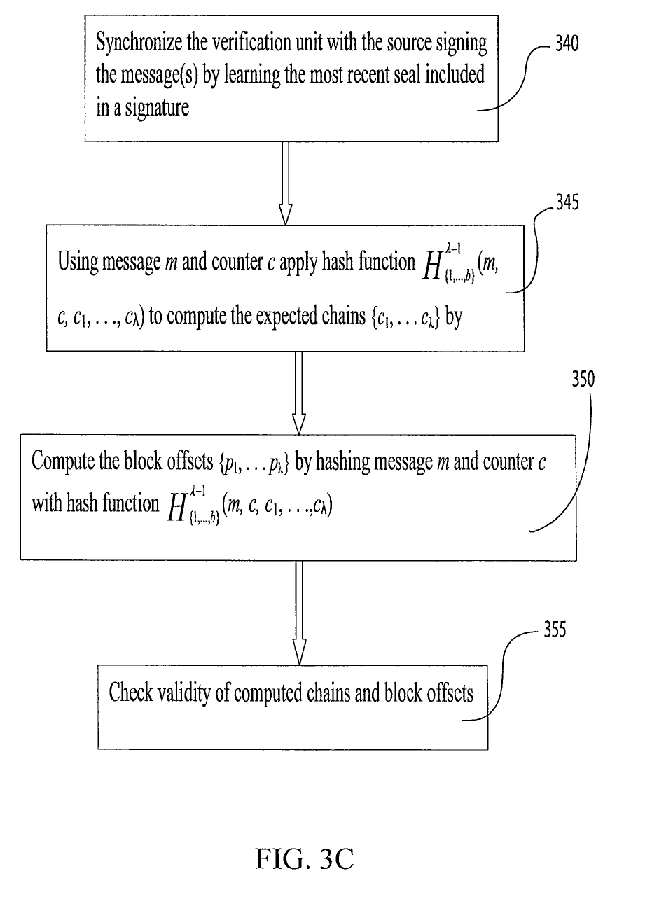

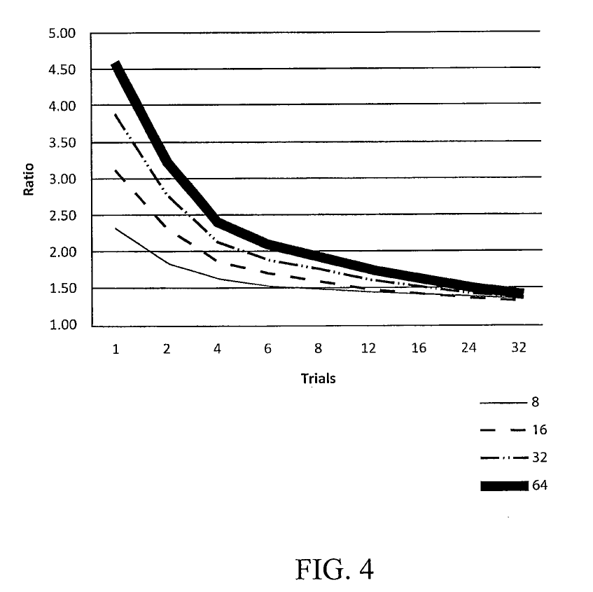

The following discussion describes the three components of the ALPS with reference to FIGS. 3A-3C, which illustrate a process embodying the present invention. The key generation unit 100 contains a private key generation subunit 110 and a public key generation subunit 120. The private and public key generation works as follows. Let q denote a security parameter and H: {0,1}^{q}→{0, 1}^{q} a secure hash function. The secret key consists of n random uniformly chosen secret values s_{1,1,1}, . . . , s_{n,1,1} with s_{i,1,1}ε{0,1}^{q} for i=1, . . . , n (step 305). Each secret value s_{i,1,1} is the starting point of a hash chain of length bl+1 with parameters 1 and b. Each chain is thereby partitioned into blocks, having l blocks of size b, followed by a last block of size 1 (step 310). An item s_{i,j,k} in a chain, also referred to as seal, is addressed by chain index i, block index j, and offset k within the block. Within any chain i and block j it holds that s_{i,j,k+1}=H(s_{i,j,k}) for k=1, . . . , b−1. Between block j and block j+1 it holds that s_{i,j+1,1}=H(s_{i,j, b}). The last value of each chain becomes the public key, i.e., s_{i,1+1,1} for i=1, . . . , n (step 315). An example of an ALPS hash chain in accordance with an embodiment of the present invention is given in Table I, where n=5 chains, a signature size=3, and a block size b=3. One out of 70 possible signatures is highlighted. Note, that in general seals of a signature may use different blocks in different chains.

In the example shown in Table I, there are five chains and a block size of three. The highlighted example signature uses chain 1, chain 4, and chain 5. There are ten different possibilities to select 3 out of 5 chains:

1, 2, 3

1, 2, 4

1, 2, 5

1, 3, 4

1, 3, 5

1, 4, 5

2, 3, 4

2, 3, 5

2, 4, 5

3, 4, 5

The block offsets in this example are 1 (chain 1), 3 (chain 4) and 2 (chain 5). These block offsets sum up to 6. There are seven possibilities to select three block offsets from the order [1, 2, 3] where the sum equals 6:

1+2+3=6

1+3+2=6

2+1+3=6

2+3+1=6

3+1+2=6

3+2+1=6

2+2+2=6

The total number of possibilities to create a signature is then given by multiplying the number of possibilities to select chains with the number of possibilities to select block offsets—for this example, 7 *10=70.

TABLE I

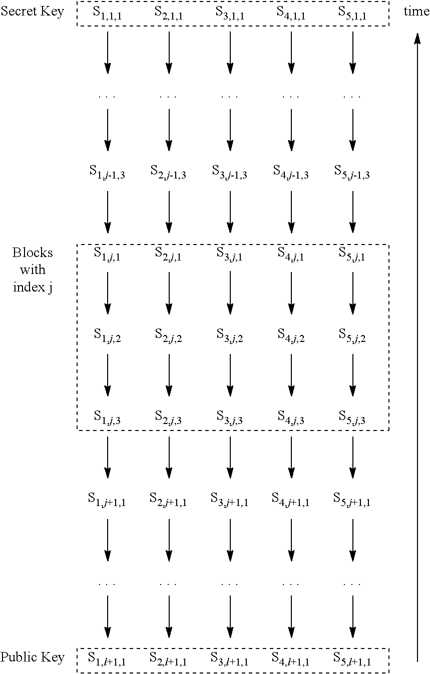

In the signing unit 200, a message m is signed by carefully including seals of a subset of chains in the signature. A signature is thereby encoded by both the seals' chains and its offsets within the blocks. Note that the protocol is randomized and may fail with non-negligible probability. A counter c allows multiple trials to be performed until the signature generation succeeds. Indices u₁, . . . , uₙ are initially set to 1; they determine the next available blocks of the chains 1, . . . , n. The signing unit 200 contains a chain selection unit 210, an offset selection unit 220, and a signature generator 230.

The number of seals included in a signature is given by λ. In the chain selection unit 210, a secure hash value of the message m and counter c are used to select a distinct set of chains {c₁, . . . , c_{λ}} with cᵢε{1, . . . , n}, denoted as H_{{1, . . . , n}}^{λ,distinct} (m, n) (step 320). From each of the λ selected chains, a seal will be included in the signature produced by the signing unit 200.

In the offset selection unit 220, a block offset pᵢε{1, . . . , b} is selected for each selected chain cᵢ (Step 325). As a security precaution, the offsets p₁ are selected to sum up to a constant t=½λ(1+b). The constant t corresponds to the expected value of a sum of offsets chosen uniformly at random and thereby maximizes the number of possible offset combinations. The first λ−1 offsets are again chosen by a secure hash function, denoted as (m, c, c₁, . . . , c_{λ}). The selection of chains {c₁, . . . , c_{λ}} from the chain selection unit 210 is provided as input to the offset selection unit 220, and added to the hash function along with the message m and the counter c as a further security precaution. Note that in contrast to chains, offsets do not have to be distinct. The remaining offset p_{λ} is chosen such that the offsets sum up to the constant t (step 330). Since offsets are strictly non-negative and smaller or equal to the block size b, the selection may fail to sum up. In this case, the counter c is increased by 1 and the algorithm restarts in the chain selection unit 210.

The signature generation unit 230 creates the signature. The chains {c₁, . . . , c_{λ}} and block offsets {p₁, . . . , p_{λ}} have been chosen in the chain selection unit 210 and the offset selection unit 220, respectively. The block indices are given by the indices {u_{c1}, . . . , u_{cλ}}. The corresponding seals s_{c1,uc1,p1}, . . . , s_{cλ,ucλ,pλ} and the counter c constitute the signature for message m (step 335). The signing unit 200 then decrements each of the indices {u_{c1}, . . . , u_{cλ}} by one to point to the next unused block. If any of the chains has been used and no further blocks are available, a new public and secret key is generated. The final algorithm for signing a message is summarized by Algorithm 1.

Algorithm 1

[symbol]

| 1: | var u₁, . . . , uₙ := l | | | | |
|---|---|---|---|---|---|
| 2: | | | | | |
| 3: | function sign(m) | | | | |
| 4: | | c := 0 | | | |
| 5: | | while not finished do | | | |
| 6: | | | {c₁, . . . , c_{λ}} := H_{{1,...,n}}^{λ,distinct}(m, c) | | |
| 7: | | | {p₁, . . . , p_{λ-1}} :=H_{{1,...,b}}^{λ-1}(m, c, c₁, . . . ,c_{λ}) | | |
| 8: | | | s = sum{p₁, . . . ,p_{λ-1}} | | |
| 9: | | | $t = \frac{λ * ( 1 + b )}{2}$ | | |
| 10: | | | if s < t and s >= t − b then | | |
| 11: | | | | p_{λ} := t − s | |
| 12: | | | | $sig := \{ {s}_{{c}_{1} , {u}_{{c}_{1}} , {p}_{1}} , … , {s}_{{c}_{λ} , {u}_{{c}_{λ}} , {p}_{λ}} , c \}$ | |
| 13: | | | | for i = 1, . . . , λ do | |
| 14: | | | | | u_{c}_{ᵢ} := u_{c}_{ᵢ} − 1 |

| | |
|---|---|
| 15: | od |
| 16: | return sig |

| | |
|---|---|
| 17: | fi |
| 18: | c = c + 1 |

| | |
|---|---|
| 19: | od |

| | |
|---|---|
| 20: | end function |

The verification unit 300 works in a similar fashion as the signing unit 200 in verifying the signature of a message m. The message and the counter included in the signature determine a selection of chains and block offsets. For each seal included in the signature, a verifying unit 310 follows the hash chain until a known seal is reached, either from the public key or from previous signatures. If no known seal is reached after 2b steps or preceding seal is known for any of the chains, the signature is considered to be invalid. Otherwise, the number of steps determines the blocks offsets of the seals. If they match the ones selected by the message and the counter, then the signature is considered to be valid, and the message can be forwarded.

As is known in the art, a hash chain is a basic cryptographic tool that is widely used. The algorithms MD5 or SHA-1, for example, are secure hash functions. A secure hash function computes an output value from a given input value. Although the function itself need not be a sophisticated mathematical operation, it is very difficult to guess the input value if only the output value is known. Accordingly, a secure hash function is difficult to invert the function. A hash chain is generated by repeatedly applying the hash function to an input value. If “H” represents a hash function, then a hash chain can be expressed as:

input
H(input)
H(H(input))
H(H(H(input)))
H(H(H(H(input))))
H(H(H(H(H(input)))))
. . .

Knowing the input value allows computation of all the values in the hash chain. Knowing only an intermediate value within the hash chain, and the hash function, allows computation of subsequent values. However, preceding values earlier in the hash chain could not be computed. Thus, the input is secure.

For example, if H(H(input)) is known, H(H(H(input))), H(H(H(H(input)))) and H(H(H(H(H(input))))) can be computed. However, H(input) can not be computed because the hash function H is difficult to invert.

The verification unit 300 needs to be weakly synchronized with the source signing the messages prior to verifying incoming messages (step 340). Weak synchronization is performed by learning for each chain the most recent seal included in a signature. This information may be obtained from either the source itself, a trusted third-party or an untrusted third-party. However, if obtained from an untrusted third party, the information needs have been time stamped and signed by the source itself using a classical signature scheme such as RSA, DSA, etc. At all time, the verification unit 300 has to ensure that this information is up-to-date, otherwise the information must be obtained again.

Verifying the signature of an incoming message m works in a similar fashion as signing a message. The signature consists of a counter c and λ seals. First, the expected chains {c₁, . . . c_{λ}} and block offsets {p₁, . . . p_{λ}} for the included seals are computed using message m and counter c. The same formulas are applied as for signing a message. The chains are computed by hashing the message m along with the counter c to H_{{1, . . . , n}}^{λdistinct} (m, c) (step 345). The block offsets {p₁, . . . p_{λ}} are then computed by hashing message m, counter c and the chains {c₁, . . . c_{λ}} to H_{{1, . . . , b}}^{λ-1} (m, C, c₁, . . . , c_{λ}) (step 350).

Two conditions have to be met for the signature to be considered valid. First, the seals included in the signature have to belong to the expected chains {c₁, . . . c_{λ}} and match the block offsets {p₁, . . . p_{λ}} derived from the message m and counter c. And second, the seals included in the signature have to be new, i.e., the seals and subsequent seals in the corresponding chains have not been used in earlier signatures.

In order to check the chains and block offsets, the verifier has to follow the hash chains of all included seals until a known seal is reached in the respective chain, either a seal from a previous signature or a seal from the public key. If no known seal is reached after 2b steps for one or more seals, the seals are not considered to be from valid chains and the signature is rejected (step 355). Otherwise, the block offsets of the known seals along with the number hash function evaluations to reach these seals allow the computation of the block offsets of the new seals included in the current signature. If all the computed block offsets match the ones computed by the hash function, then both the seals' chains {c₁, . . . , c_{λ}} and their block offsets {p₁, . . . p_{λ}} are considered to be valid. Furthermore, if the reached seals are the most recent ones known to the verifier, then the seals are considered to be new, the signature for the message m is accepted, and considered valid with high degree of probability.

### Evaluation

The following discussion evaluates the ALPS signature scheme embodying the present invention with respect to security, computational complexity, signature size, and public key size.

Security

ALPS is a one-time signature scheme that can be used once during the propagation delay of the peer-to-peer network to maintain its security. Once a new block is signed, the source of the stream has to wait until the block reaches all peers connected to the peer-to-peer network. Multiple independent ALPS instances facilitates the signing of sign multiple blocks during the propagation delay. Otherwise, peers may not be aware of the boundary of used and unused blocks. The security provided by ALPS stems from the fact that the source holds all seals of all chains as a secret key, while an attacker is limited to seals from previous signatures and subsequent seals in the respective chains. If peers are aware of the boundary of used and unused blocks, it limits an attacker further to the seals of the most current signature and subsequent seals of the respective blocks. If a peer receives a signature first, an attacker has no seals at all to work with. Since offsets of seals in a signature sum up to constant t, it is not possible that, for example, an unfortunate block selects the first seal of each block, exposing all subsequent seals in the respective blocks and limiting security to the selection of chains. Furthermore, an attacker is not able to replace any of the seals of the current signature by a subsequent seal since it would force the use of a preceding (secret) seal in another chain, considered to be computationally infeasible. Consequently, a forged signature would have to select exactly the same chains and offsets, considered to be computationally infeasible for a sufficient number of chains and a sufficient block size if the selection is performed by secure hash functions. Therefore, the security provided by ALPS is given by the number of possible signatures, determined by the number of chains n, signature size λ, and block size b.

Selection of a One-Way Function

The security and performance of ALPS is founded on the selection of an appropriate one-way function to compute the hash chains. The function has to be one-way to provide robustness against preimage attacks. Otherwise, an attacker may simply invert the hash chains, depriving a signer of his advantage of being the sole peer knowing all seals. The selected function further has to withstand second preimage attacks.

A second preimage attack would enable an attacker to compute a new block that has the same signature as an given existing block. But note that in contrast to secure hash functions, there is no need for collision resistance, which is considered to be more difficult to achieve. In ALPS, a source could sign two blocks with the same signature by finding a collision, but this neither breaks authenticity nor is it of any use to an attacker.

A peer-to-peer streaming platform can use the MD5 function because of its low computational complexity and robustness against premiage and second preimage attacks. While there are known attacks on MD5 speeding-up the search for second reimages in very large messages and collisions, streams produced by embodiments of the present invention are resistant to such attacks because of the small data blocks.

The design of ALPS allows further optimizations. For example, when following hash chains, the output of an iteration is used as input in the next iteration, allowing to keep values within CPU registers. Furthermore, it is possible to follow different hash chains concurrently, allowing the use of both multi-core processors and special instructions like Streaming SIMD Extensions (SSE). SSE allows to perform 128-bit vector operations and is readily available in personal computers since 2001. For an MD5 function, based on 32-bit operations, SSE allows to compute four hash values simultaneously. This way, a C++ implementation running on a 2.66 GHz processor is able to perform 16 million hash operations per second with a single processing core.

Randomized Signing

The signature generation of ALPS is randomized and fails with non-negligible probability. To determine the failure probability, a normal distribution is used to approximate the distribution of the first λ−1 offsets' sum p₁+ . . . +p_{λ-2}. Expected value μ and variance σ² are thereby given by:

$$\begin{matrix}μ \approx \frac{1}{2} \int b ( λ - 1 ) & eq . 1 \\ {σ}^{2} \approx \frac{1}{12} \int {b}^{2} ( λ - 1 ) & eq . 2\end{matrix}$$

In order for all offsets, including p_{λ}, to sum up to t, the sum is allowed to deviate no more than b/2, leading to an estimate for the failure probability p_{fail}:

$${P}_{fail} \approx 1 - {Φ}_{μ , {σ}^{2}} ( μ + \frac{b}{2} ) + {Φ}_{μ , {σ}^{2}} ( μ - \frac{b}{2} ) \qquad eq . 3$$

Fortunately, the failure probability p_{fail} varies between 22% for signatures with λ=3 seals and 56% with λ=10 seals. In any case, this randomness introduces only a minor computational overhead.

Signature Size

The parameters n, b, λ and q provide trade-offs between computational cost, public key size, signature size, and security. In the case of peer-to-peer live streaming or gaming, a moderate security level between 2⁵⁰ and 2⁶⁰ is usually sufficient since data blocks expire within few seconds. For example, a peer-to-peer streaming platform can distribute data blocks among millions of peers within one to two seconds if sufficient bandwidth is available. As discussed above, see Security, the number of different ALPS signatures S essentially determines the security level. Failure probability p_{fail} from the previous section thereby allows to approximate S.

$$S \approx ( 1 - {P}_{fail} ) {b}^{λ - 1} ( \begin{matrix}n \\ y\end{matrix} ) \qquad eq . 4$$

As an example, n=50 chains, λ=5 seals in a signature, and block size b=489 yields a value of S=256. The verification time t_{verify}, is mainly given by the number of one-way function evaluations i.e., the product of λ and b. In the given example, MD5 has a verification time t_{verify}=153 μs. Table II depicts the verification times in μs for a given security level S, number of chains n, and signature size λ.

TABLE II

| S | ? | N = 25 | N = 50 | N = 100 | N = 200 |
|---|---|---|---|---|---|
| 2⁴⁸ | 4 | 805 | 306 | 119 | 47 |
| | 5 | 96 | 38 | 16 | 7 |
| | 6 | 30 | 12 | 5 | 4 |
| 2⁵⁶ | 4 | 5,111 | 1,943 | 755 | 297 |
| | 5 | 383 | 153 | 63 | 26 |
| | 6 | 89 | 36 | 15 | 7 |
| 2⁶⁴ | 5 | 1,533 | 610 | 250 | 104 |
| | 6 | 269 | 110 | 46 | 19 |

Of special interest is the case where the number of chains n matches the signature size λ. Table 3 shows the block size and verification time t_{verify}, required to reach security level S=248 for different signature sizes λ. Naturally, either more seals in the signatures or a larger block size is required to compensate for the lack of flexibility in selecting chains. In contrast, in accordance with the present invention, public keys become small and synchronization is limited to knowing the current block index used by all chains.

TABLE 3

| ? = n | B | t_{verify} |
|---|---|---|
| 5 | 4,656 | 1,455 μs |
| 6 | 875 | 328 μs |
| 7 | 287 | 126 μs |
| 8 | 129 | 64 μs |
| 9 | 71 | 40 μs |
| 10 | 45 | 28 μs |

The size of signatures is given by the number of seals λ and the seal size. While MD5 outputs 128-bit values, between 48 to 72 bits are sufficient if data blocks expire quickly and robustness against preimage attacks is given. In case of λ=5 and S−256, the signature size is 35. Some care has to be taken since hash chains have a lifetime from several minutes to hours. Adding an additional chain, known as a salt chain, can resolve the problem. To then compute a seal in a seal chain, the salt is added as input, along with the previous seal in the respective chain, to the one-way function. A more detailed discussion about salt chains is available in the art.

Typically, only intermediate seals of each chain are stored by the signer to save space, increasing the computational complexity of signing as the signer has to follow hash chains as well. If, for example, the seal at the beginning of each block is stored, then the signing time is about half the verification time. It is possible to implement ALPS without fixed blocks, also reducing the verification time by a factor of two at the cost of a more difficult synchronization.

Comparison to Other Schemes

Table 4 depicts a comparison of the ALPS signature scheme embodying the present invention with the conventional schemes of RSA, DSA, and ECDSA. Table 4 shows the computational complexity (μs) to sign and verify messages, and their signature sizes (bits) for each of these schemes. Tests of these schemes were performed with Java 6 using the same 2.66 GHz processor to obtain these results. While RSA signatures are quickly verified, signing is computationally expensive and, more importantly, the signature size is too large to sign network packets with a typical maximum transmission unit (MTU) of 1,500 bytes. In contrast, DSA features small signatures but incurs high computational costs. And finally, ECDSA, based on elliptic curve cryptography, allows the use of shorter keys, but is computationally the most expensive one out of the three schemes.

TABLE 4

| | Key | Signature | T_{sign} | T_{verify} |
|---|---|---|---|---|
| DSA | 1024 | 376 | 4064 | 8875 |
| RSA | 1024 | 1024 | 6150 | 324 |
| ECDSA | 256 | 568 | 23006 | 30409 |

The ALPS signature scheme embodying the present invention has advantages over the conventional BiBa, Powerball, and HORS signature schemes discussed above. While the BiBa, Powerball, and HORS schemes allow signing of multiple data blocks during the propagation delay, ALPS provides advantages over these schemes. First, ALPS makes use of smaller public keys, which in turn allows the use of more instances. Second, the security of BiBa, Powerball, and HORS decreases exponentially with every signed block.

For example, signing four blocks with λ=6 seals each gives an attacker about 217 possibilities to select seals for its own, forged signature. Assuming that 1,000 chains are used, another five seals would be needed to maintain the same security level as the additional seals further boost the number of possibilities to 233. Taking the example from the previous section, BiBa requires the use of 6,000 chains to maintain a security level S=256 with λ=5 seals if it is used once during the propagation delay. This is highly undesirable both for public key distribution and for keeping peers up-to-date about the boundary of used and unused blocks. The later issue can be solved by moving forward in all chains with every signature, as noted above. But under this condition BiBa further loses its performance advantage over ALPS while still having a large public key. Powerball and HORS perform similar to BiBa. In any case, the performance of ALPS is more than adequate to authenticate a large number of small blocks.

Propagation Delays

Signing times in an ALPS signature scheme embodying the present invention are short. A way to improve security at the cost of (slightly) longer signing times is to increase the computational complexity for signing blocks. While the impact is small for an honest signer, it becomes considerably harder for an attacker to forge a signature. A simple solution is to lower the success probability for singing blocks. Enforcing that a signature further satisfies H_{{0, . . . , θ-1}}¹ (c, c₁, . . . , c)=β with θ=1024 and β=0 decreases the success probability by factor θ for both signers and attackers.

A more sophisticated scheme may choose a non-random β. A peer-to-peer streaming platform can make use of propagation delays. Namely, solely the source of a live stream has all blocks in its buffer. It takes time for blocks to reach other peers, especially since, different blocks usually travel along different paths to avoid bottle-necks and single point of failures. To sign a new data block, the source hashes log(θ) preceding blocks to one bit each, and sets β to their concatenation. Other peers subsequently verify the bits for preceding data blocks they already received. There is a good chance that a malicious peer gets caught for sending forged blocks because its signatures are based on incomplete knowledge of the preceding blocks.

Synchronizing Peers

Peers have to be weakly synchronized with the source in order to be aware of the boundary of used and unused blocks. While there are no guarantees to receive blocks in time, a variety of techniques help to maintain synchronization. For example, while insufficient bandwidth may prevent the download of blocks, peers should retrieve the much smaller signatures.

Hash lists complement ALPS to both increase security and to help keeping boundaries up-to-date. The ALPS signature scheme embodying the present invention can be used during the initial distribution of new blocks until hash lists become available. Blocks are then double checked and boundaries updated if necessary. Each security requirements for ALPS and larger block sizes within hash lists offset any additional overhead.

Hash lists further enable newly joined peers to gain synchronization by downloading the most recent hash lists, signatures, and either blocks or their (small) hash values. The synchronization is completed as soon as the seals in the download signatures cover all chains. The well known coupon collector problem provides an approximation for the expected number of downloads. Note that seals within a signature are from distinct chains, leading to slightly smaller expectations compared to the coupon collector problem. A peer has to download about

$$\frac{n log ( n )}{λ}$$

signatures. Fewer chains in ALPS compared to schemes like BiBa make this approach viable in practice. Using the power of two choices gives further improvements as depicted in FIG. 3, which depicts the expected number of seals required per chain to synchronize with 8, 16, 32 and 64 chains and balancing with 1 to 32 trials.

For example, with n=64 chains and λ=4 seals in a signature, a peer has to download 4.6 times as many seals as there are chains to synchronize (296 seals in total). In contrast, getting the current boundary from the source would only require the download of a single seal per chain. By balancing the use of seals in signatures, i.e., generating several signatures and choosing the one with seals from chains the least used, peers synchronize more quickly. Balancing among two signatures yields a ratio of 3.3, while 16 signatures lead to a ratio of 1.6.

The ALPS signature scheme embodying the present invention makes low-delay and authenticated peer-to-peer live streaming feasible. ALPS features small signatures, fast signature generation and verification, and small public keys.

Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated.

I claim:

1. A method for generating an electronic signature to authenticate data, the method comprising the steps of:
generating, by a private key generation subunit, a private key comprised of uniformly random chosen values;
creating, by a public key generation unit, a public key using a last value in a hash chain formed from using a first secure hash function H: {0,1}^{q}→{0,1} with security parameter q and the private key values as starting points, wherein the hash chain has l blocks each of a size b, and the hash chain has a length of bl+1 blocks;
encoding, by a signing unit, a message m, wherein the encoding includes the steps of:
selecting, by a chain selection unit, a distinct set of hash chains using a second secure hash value of the message m and a counter c, wherein the second secure hash function is denoted by H_{{1, . . . , n}}^{λ,distinct}, wherein λ is the number of chains in the set;
selecting, by an offset selection unit, a block offset for each selected hash chain by adding the selected chains, the message m, and the counter c in a third hash function denoted by H_{{1, . . . b}}^{λ-1} (m, c, c₁, . . . , c_{λ});
creating the electronic signature s_{c1,uc1,p1}, . . . , s_{cλ,ucλ,pλ} of the message m, by a signature generator, wherein {c₁, . . . , cλ} represents the selected chains, {p₁, . . . , p_{λ}} represents the block offsets and {u_{c1}, . . . , u_{cλ}} represents indices of the blocks.

2. The method of claim 1, further including the steps of:
summing the block offsets; and
if the block offset sum does note equal ½λ(1+b), increasing the value of counter c by 1 and repeating the encoding step.

3. The method of claim 1, further including the steps of:
decreasing, by the signature generator, the indices {u_{c1}, . . . , u_{cλ}}; and
if any of the selected chains have been used and no further blocks remain, repeating the generating a private key and creating a public key steps;
otherwise, continue creating the electronic signature.

4. A method for verifying a validity of an electronic signature, the method comprising the steps of:
weakly synchronizing a verification unit with a source of a signed message by receiving a seal in the electronic signature from the source or a trusted third party;
computing, by a verifying unit, a set of expected chains by hashing the signed message m and a counter c with a first hash function denoted H_{{1, . . . , n}}^{λdistinct} (m, c);
computing, by a verifying unit, a set of expected block offsets by hashing the signed message m, the counter c, and the computed chains {c₁, . . . c_{λ}} with a second hash function denoted H_{{1, . . . b}}^{λ-1} (m, c, c₁, . . . , c_{λ});
determining the validity of the electronic signature.

5. The method of claim 4, wherein the determining step includes the steps of
matching the chains in the signature to the expected chains, and the expected block offsets computed from hashing the signed message; and
ascertaining whether the chains in the electronic signature have been used in a prior electronic signature.

6. The method of claim 4, wherein if the received seal is received from an untrusted third party, the method further includes the step of performing the synchronizing of the verification unit only if the received seal is time stamped and signed by the source of the signed message.

7. A system for generating an electronic signature to authenticate data, the system comprising:
a private key generation subunit configured to generate a private key comprised of uniformly random chosen values;
a public key generation unit configured to generate a public key using a last value in a hash chain formed from using a first secure hash function H: {0,1}^{q}→{0,1} with security parameter q and the private key value as starting points, wherein the hash chain has l blocks each of a size b, and the hash chain has a length of bl+1 blocks;
a signing unit configured to encode a message m, wherein the signing unit includes:
a chain selection unit configured to select a distinct set of hash chains using a second secure hash value of the message m and a counter c, wherein the second secure hash function is denoted by H_{{1, . . . , n}}^{λ,distinct}, wherein λ is the number of chains in the set;
an offset selection unit configured to select a block offset for each selected hash chain by adding the selected chains, the message m, and the counter c in a third hash function denoted by H_{{1, . . . , b}}^{λ-1} (m, c, c₁, . . . , c_{λ}); and
a signature generator configured to create an electronic signature s_{c1,uc1,p1}, . . . , s_{cλ,ucλ,pλ} of the message m, wherein {c₁, . . . , cλ} represents the selected chains, {p₁, . . . , p_{λ}} represents the block offsets and {u_{c1}, . . . , u_{cλ}} represents indices of the blocks.

8. The system of claim 7, wherein the signing unit is further configured to sum the block offsets, and if the block offset sum does note equal ½λ(1+b), to increase the value of counter c by 1.

9. The system of claim 7, wherein the signature generator is further configured to decrease the indices {u_{c1}, . . . , u_{cλ}}; and if any of the selected chains have been used and no further blocks remain, to generate an updated private key and create an updated public key.

10. The system of claim 7, further including:
a verification unit configured to be weakly synchronized with a source of a signed message, wherein the synchronization is done with a seal in an electronic signature received from the source or a trusted third party;
a verifying unit configured to compute a set of expected chains by hashing the signed message m and a counter c with the second secure hash function;
a verifying unit configured to compute a set of expected block offsets by hashing the signed message m, the counter c, and the computed chains {c₁, . . . c_{λ}} with the third hash function; and
the verification unit further configured to determine the validity of the electronic signature.

11. The system of claim 10, wherein the verification unit is further configured to match the chains in the signature to the expected chains, and the expected block offsets computed from hashing the signed message, and to ascertain whether the chains in the electronic signature have been used in a prior electronic signature.

12. The system of claim 10, wherein the verification unit is further configured, if the received seal is received from an untrusted third party, to synchronize only if the received seal is time stamped and signed by the source of the signed message.
